(19) United States
(12) Patent Application Publication
(10) Pub. No.: US 2016/0153510 A1
(43) Pub. Date: Jun. 2, 2016

(54) Brake Application Device For A Disk Brake System

(71) Applicant: SIEMENS AKTIENGESELLSCHAFT, München (DE)

(72) Inventors: PATRICK ROTHFUSS, PLANEGG (DE); MARTIN SCHAUTT, MUENCHEN (DE); TONI SCHIFFERS, ERKELENZ (DE)

(21) Appl. No.: 14/904,183

(22) PCT Filed: Jul. 2, 2014
(86) PCT No.: PCT/EP2014/064093

§ 371 Date: Jan. 11, 2016

(30) Foreign Application Priority Data
Jul. 11, 2013 (DE) 10 2013 213 619.6

(51) Int. Cl. F16D 66/00; F16D 55/224

(52) U.S. Cl. CPC F16D 66/00; F16D 55/2245; F16D 2055/0016

(57) ABSTRACT

A brake application device for a disk brake system includes an arm-shaped reference element for detecting any deformation caused to the brake application device when braking. The novel brake application device allows braking torque to be determined with a comparatively small degree of expenditure and in a simple manner. The brake application device of the invention therefore has a flexible zone which is bent during braking as a function of the braking torque. Adjacent to the flexible zone a braking torque sensor having an arm-shaped reference element and a sensor element which is shifted by the bending are provided. A particularly preferred embodiment refers to the system being supplemented by a brake application force sensing device.

The invention relates to a brake application device for a disk brake system, said brake application device comprising an arm-like reference element for detecting any deformation caused to the brake application device when braking.

A brake application device of this type is described in the international patent application WO 2007/012560 A1. In an embodiment for a disk brake comprising a caliper, the known brake application device is equipped with a device for measuring the current braking force. The measuring device has a component which is fastened to the caliper at its first end and is free at its second end, i.e. a gap is formed between the component and the caliper. This means that the second end is not under any force and is therefore unaffected by any widening of the caliper which occurs when a braking force is applied. The component therefore forms an arm-like reference element. Since the extent of the widening of the caliper relates to the magnitude of the braking force, the current braking force can be determined by detecting changes in the width of the gap in the region of the free end of the component by means of a suitable sensor device. For this purpose, the sensor device is mounted in the immediate vicinity of the free end of the component.

The object of the invention is to propose a brake application device which has an arm-like reference element and allows the braking torque to be determined comparatively economically and in a simple manner.

In order to achieve this object, a brake application device of the type cited above inventively includes a flexible region in which flexural bending occurs as a function of the braking torque when braking, and a braking torque sensor device is provided adjacent to said region and comprises the arm-like reference element and a tracer element that can be displaced by the flexural bending.

The German patent specification DE 10 2008 063 892 B4 discloses a braking system of a rail-borne vehicle, in which the braking torque is measured directly for the purpose of compensating for fluctuations in the conditions of friction, though the measurement of the braking torque takes place at connecting parts between the holder of a brake caliper unit and a bogie of the rail-borne vehicle in this case. A sensor system which measures force is attached to the connecting parts.

An important advantage of the brake caliper according to the invention is that the sole requirements are essentially a flexible region in the brake application device and a tracer element which follows the flexural bending in addition to the reference element in the sensor device, in order to draw an inference from the position of the tracer element relative to the reference element in accordance with known sensor principles, and to obtain a measured variable which corresponds to the braking torque. It is considered a further advantage that an estimate of the friction coefficient is not required in order to allow the braking torque to be determined.

The flexible region may be provided at various locations of the brake application device. It is considered particularly advantageous for the flexible region to be located in the vicinity of a suspension system of the brake application device, because the deformation proportionate to the braking torque is particularly pronounced there.

It is also advantageous for the flexible region to be formed by a tapering between a bridge of the brake application device, said bridge holding the brake levers of the disk brake system, and a suspension device. In the case of a brake application device which is designed as a brake caliper, this offers the further advantageous possibility of providing the taper in a plate of the supporting system which is designed as a brake bridge.

In principle, however, use of the inventive brake application device is in no way means restricted to disk brake devices featuring a brake caliper, and it can also be applied to disk brake devices featuring a caliper and for block brakes which act on a wheel rim.

It is also advantageous for the arm-like reference element to extend over the flexible region.

In a preferred embodiment of the brake application device according to the invention, the arm-like reference element is fastened at one end to that side of the flexible region which is closest to the suspension system, and the tracer element is attached to that side of the flexible region which is furthest from the suspension system. Also provided is a braking torque sensor unit, which converts the position of the reference element relative to the tracer element into a braking torque measured variable that corresponds to the braking torque.

In this context, it is also considered advantageous for the tracer element to be attached to the brake bridge and for the arm-like reference element to be attached below the suspension device.

The tracer element is moreover advantageously fastened below the neutral axis of the flexible region, and the braking torque sensor unit is so embodied as to generate a braking torque measured variable which corresponds to the angle between the tracer element and the reference element.

The braking torque sensor system can preferably be embodied as an optoelectronic sensor device or as a Hall effect sensor device. It is then advantageous for the braking torque sensor device to consist of a first sensor element which is attached to the free end of the reference element, and a second sensor element which is fastened to the tracer element and is located adjacent to the first sensor element.

In addition to foregoing, and for the purpose of verifying the braking torques determined in the manner described above, it may also be advantageous to provide a force measuring pin in the suspension system.

In a particularly advantageous embodiment of the brake application device according to the invention, at least one brake application force sensor device having a tracer component is attached to at least one brake lever of the brake application device in such a way that it outputs a brake application force measured variable which corresponds to the extent of the flexural bending of the brake lever when braking. Specifically, this has the advantage that the additional measurement of the brake application force allows the braking torque measured variable and the brake application measured variable to be validated and the two measured variables to be balanced. This means that highly dynamic braking control processes can be implemented.

The brake application force sensor device may be configured in various ways. It is considered particularly advantageous for the brake application force sensor device to have a reference part in addition to the tracer part, for the reference part to be fastened on one side at its end facing the pivot point of the brake lever, and for the tracer part to be connected to the brake lever in such a way that it follows the deformation of the brake lever. Also provided is a brake application force sensor unit, which converts the position of the reference part relative to the tracer part into a brake application force measured variable which corresponds to the brake application force. The brake application force sensor device itself can therefore be structurally designed in exactly the same manner as the braking torque sensor device, this being advantageous in terms of the manufacturing costs of the brake application device.

In this context, it is also advantageous for the reference part and the tracer part to be positioned on at least one lateral surface of the brake lever and for the brake application force sensor unit to be so embodied as to generate a brake application force measured variable which corresponds to the angle between the tracer part and the reference part.

However, it is also possible in principle for the reference part and the tracer part to be positioned on an inner and/or an outer surface of the brake lever and for the brake application force sensor unit to be so embodied as to generate a brake application force measured variable which corresponds to the distance of the tracer part from the reference part.

In the context of the brake application device according to the invention, it is further advantageous for the brake application force sensor unit to comprise a first sensor part which is attached to the free end of the reference part, and a second sensor part which is fastened to the tracer part. In this way, the first sensor part can advantageously be integrated in the reference part.

Like the braking torque sensor device, the brake application force sensor unit can be an optoelectronic sensor unit or a Hall effect sensor unit.

It is also possible here advantageously to provide a radio connection from the brake application force sensor unit to a central evaluation device.

In order to explain the invention further,

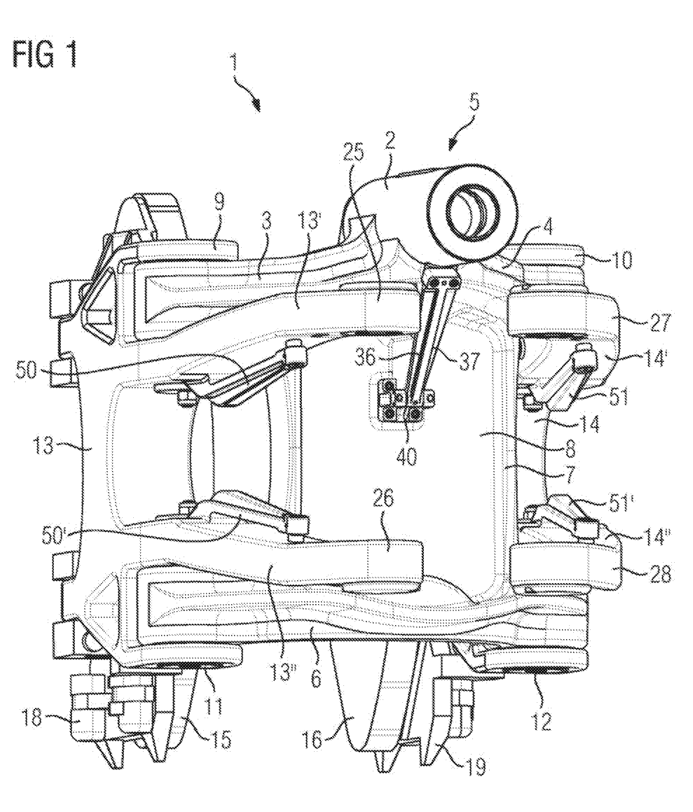

FIG. 1 shows a plan view of an exemplary embodiment of the brake application device according to the invention for a disk brake which is designed in the form of a brake caliper,

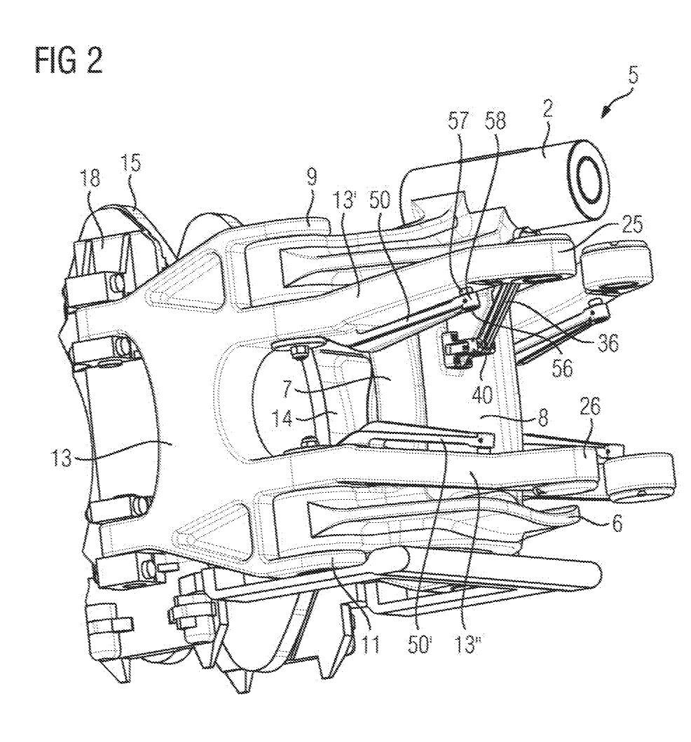

FIG. 2 shows a further plan view of the same exemplary embodiment,

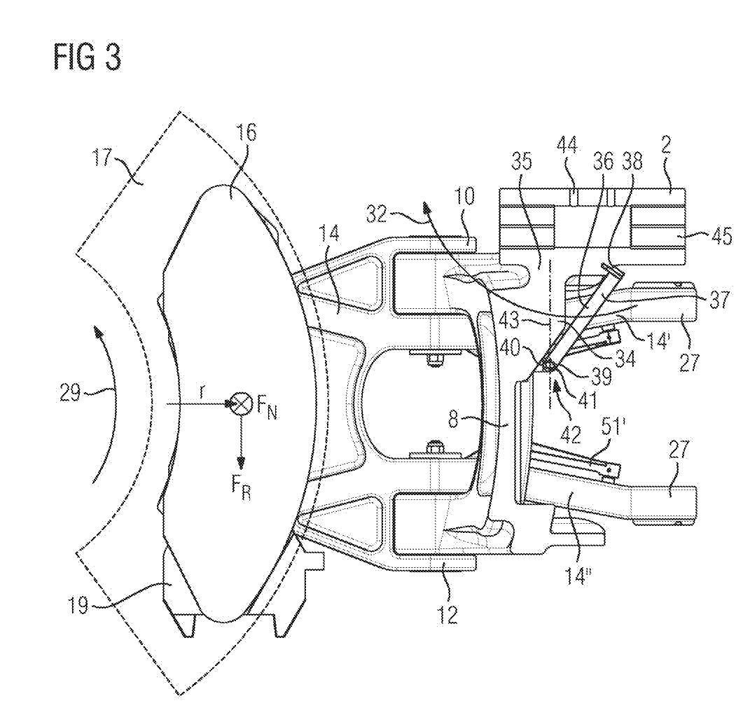

FIG. 3 shows a cross section of the same exemplary embodiment, and

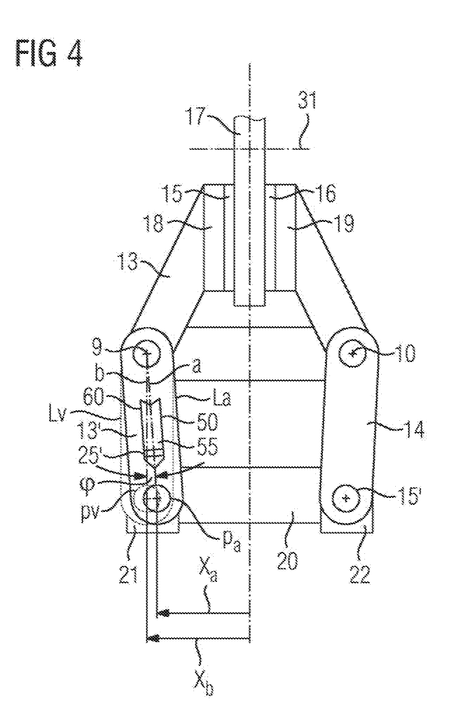

FIG. 4 shows the relevant components in a schematic view from above in order to illustrate the structure and operation of the brake application force sensor device of the same exemplary embodiment,

wherein the same reference signs are used in each case for the same components of the brake application device in the various illustrations.

The brake application device 1 illustrated in the figures has a suspension system 2, by means of which the brake application device 1 may be attached to e.g. a chassis (not shown) of e.g. a rail-borne vehicle, e.g. a bogie. However, the brake application device 1 may also be securely connected to other devices of a rail-borne vehicle.

A left-hand upper cross strut 3 and a right-hand upper cross strut 4 extend laterally to the left and right of the mounting system 2. In this case, the mounting system 2 and the two upper cross struts 3 and 4 may be manufactured e.g. as an integrated upper cross strut unit 5 as shown in the figures. Below the upper cross strut unit 5 is located a corresponding lower cross strut unit 6, this being arranged opposite the upper cross strut unit 5. The upper and the lower cross strut units 5 and 6 are preferably securely connected together. A frame 7 is provided as a link between the two cross strut units 5 and 6. In order to prevent foreign bodies such as dirt particles, brake pad dust, humidity, etc. from penetrating through the frame 7, the frame 7 is sealed or filled in by a plate 8 which serves as a protective plate. The frame 7, the plate 8, the lower cross strut unit 6 and the upper cross strut unit 5 are preferably developed integrally in the form of a cast part, which then represents a so-called brake bridge.

Upper bearing points 9 and 10 are situated on the upper cross strut unit 5 in each case. Lower bearing points 11 and 12 are provided on the lower cross strut unit 6 correspondingly, wherein rotational axes of the lower bearing points 11 and 12 are coaxially aligned relative to the opposing upper bearing points 9 and 10. Opposing bearing points 9 and 11 or 10 and 12 therefore form a bearing point pair in each case, wherein the bearing points 9 and 11 represent a left-hand bearing point pair and the bearing points 10 and 12 represent a right-hand bearing point pair.

Departing from the exemplary embodiment shown here, the corresponding bearing point pairs may also be combined to form a single bearing. However, the paired configuration of the bearing points has advantages in terms of the distribution and support of the bearing forces.

A left-hand brake lever 13 and a right-hand brake lever 14 are rotatably attached to the left-hand bearing point pair via the bearing points 9 and 11 and to the right-hand bearing point pair via the bearing points 10 and 12 respectively. The two brake levers 13 and 14 can therefore be pivoted about the upper cross strut unit 5 and the lower cross strut unit 6, i.e. about the brake bridge. By virtue of the opposing and preferably axially symmetrical arrangement of the brake levers 13 and 14, the front ends of the brake levers can be moved towards or away from each other. This allows brake pads 15 and 16 attached at the front ends of the brake levers 13 and 14 to be pressed against or released from a brake disk 17 that is to be braked (cf. FIG. 3 in particular). The brake disk 17 is effectively grasped in the brake caliper as a result of a brake application movement of the two brake levers 13 and 14, whereby a frictional force which retards the rotational movement is applied to the brake disk 17 on both sides, said frictional force resulting from the normal force on the brake pads 15 and 16.

The brake pads 15 and 16 may be connected to the respective brake levers 13 and 14 in a known manner via brake pad retaining devices 18 and 19. The connection between the brake pad retaining devices 18 and 19 and the brake levers 13 and 14 is configured such that any tilting or any skewed or angled application of the brake pads 15 and 16 to the brake disk 17 due to the pivoting movement of the brake levers 13 and 14 can be equalized as far as possible. To this end, the brake pad retaining devices 18 and 19 may themselves be mounted in the brake levers 13 and 14 in a pivoted manner, though for the sake of clarity this is not shown.

An actuator 20 is used to activate the brake levers 13 and 14, and is schematically illustrated in FIG. 4. The actuator 20 is integrated in the brake application device 1. The actuator 20 is connected to the rear ends of the brake levers 13 and 14 via left-hand and right-hand linkages 21 and 22. In the case of an actuator 20 which can be extended and retracted in a linear manner (see FIG. 4), one linkage 21 or both linkages 21 and 22 can be axially displaced.

As shown in FIGS. 1 to 3 in particular, each of the brake levers 13 and 14 has two bearing limbs 13′ and 13″ or 14′ and 14″ respectively. A left-hand bearing pair and a right-hand bearing pair, consisting of the left-hand upper and lower bearings 25 and 26 on the bearing limbs 13′ and 13″, and the right-hand upper and lower bearings 27 and 28 on the bearing limbs 14′ and 14″, are used to transfer the linear movement of the actuator 20 to the brake levers 13 and 14. In this case, the brake levers 13 and 14 are rotatably connected to the actuator 20 or to the linkages 21 and 22 thereof. This means that the left-hand linkage 21 is accommodated between the upper and the lower bearing limbs 13′ and 13″, and the right-hand linkage 22 between the upper and the lower bearing limbs 14′ and 14″, as shown in FIG. 1 in particular. If the actuator 20 now generates a (linear) displacement movement between the linkages 21 and 22, the brake levers 13 and 14 are caused to pivot about the brake bridge or the upper and lower cross strut units 5 and 6 via their associated bearing pairs comprising the bearings 25 and 26 or 27 and 28 respectively. In order to apply the brake, the actuator 20 moves the brake levers 13 and 14 apart at their ends which feature the bearing limbs 13′ and 13″ or 14′ and 14″ respectively, thereby pressing together those ends of the brake levers 13′ and 14′ which support the brake pads 15 and 16. The brake caliper is opened if the process is reversed.

The actuator 20 itself may be embodied as an (electro)mechanical, (electro)pneumatic or (electro)hydraulic activation device. In the case of a hydraulic or pneumatic activation unit, a linearly extending stroke cylinder may be used as an actuator. Linear motors having a transmission which converts the rotational movement into a linear movement can be used as electromechanical actuators. Spring-loaded actuators can also be used.

In order to explain the braking torque sensor device in greater detail, the following makes reference to FIG. 3 in particular.

It is assumed that the brake disk 17 rotates in the direction of the arrow 29. As a result of pressing the brake pad 16 against the brake disk 17, a normal force FN is established. This results in a frictional force FR, which produces a braking torque Mr over the frictional radius r starting from a rotational axis of the brake disk 17. Given that actio=reactio, this braking torque Mr will also act on the brake pad 16 and therefore via the brake application device 1 on the suspension system 2. This means that, as a result of the influence of the braking torque Mr, the brake application device 1 tends to flex about its suspension system 2 as indicated by the arrow 32. In this respect, the degree of the deformation represents a measurable value for the magnitude of the braking torque Mr.

In order to optimize the measurement of the braking torque Mr, a flexible section 35 that is tapered and/or pinched is selected at a location 34. By virtue of this pinching and/or tapering, which is advantageously positioned at the transition zone between the brake bridge comprising the cross strut units 5 and 6 and the suspension system 2, and despite the generally rigid design of the brake bridge and the suspension system 2, a flexible region 35 can then be provided which is suitable for determining a deformation. The region 35, which is locally limited in an otherwise rigid construction, is therefore provided specifically for the purpose of the measurement and intentionally allows a monitored deformation. By means of an appropriate configuration of the taper, it is possible in this case to ensure that the deformation resulting from an active braking torque Mr is characterized almost exclusively by a vertical movement, i.e. an upward or downward movement, and to avoid any interference movement caused by lateral deflection, for example. This allows a simpler structure of the braking torque sensor device since only deformation in single plane, namely the plane shown in FIG. 3, need be detected.

Depending on the maximum braking forces that can occur, the tapering and/or pinching in the flexible region 35 may be realized to a greater or lesser extent, thereby ensuring at all times that the brake application device 1 cannot fracture or break off in the region of the flexible region 35.

A braking torque sensor device 36 is used to detect the deformation of the flexible region 35 caused by the braking torque Mr, and has an arm-like reference element 37. This reference element 37 characterizes the free braking state, because it is securely connected at one end to the suspension system 2, e.g. via a screw connection 38. Since the suspension system 2 is used as a connection element for the purpose of fastening the brake application device 1, the suspension system 2 is so designed as to be quasi rigid. Consequently, the arm-like reference element 37 is not subjected to any significant deformation, even in the case of high braking torques Mr.

A tracer element 39 of the braking torque sensor device 36 is connected to the brake bridge comprising the cross strut units 5 and 6, and therefore follows the flexural bending of the flexible region 35. Both the reference element 37 at its end and the tracer element 39 are each equipped with a sensor element 40 and 41 respectively (both sensor elements 40 and 41 form a braking torque sensor unit 42), wherein the sensor element 41 of the tracer element 39 is attached vertically below the flexible region 35 on an imaginary axis 43 which runs vertically through the flexible region 35. Therefore the sensor element 41 can reliably capture the deformation that occurs, thereby assisting the measurement of the braking torque Mr. When the braking torque Mr is present, the brake application device 1 flexes in this region due to the flexible region 35, such that the brake bridge containing the flexible region 35 executes a pitching movement as indicated by the arrow 32. The sensor element 41 on the tracer element 39, being connected to the brake bridge, therefore performs a movement relative to the sensor element 40 which is connected to the reference element 37, and said relative movement is detected by the braking torque sensor unit 42. In this case, the relative movement increases according to the current braking torque Mr. This detected relative movement is therefore used as a representative measured variable for the presently occurring braking torque Mr. The braking torque measured variable thus determined can be converted into the corresponding braking torque Mr by means of an evaluation device (not shown). The transmission of signals to the evaluation device may be effected via a wireless radio link.

If the brake disk 17 rotates in the opposite direction to the arrow 29, the measurement principle functions in a similar manner, the brake bridge being deformed in the opposite direction to the arrow 32. Since the reference element 37 describes the state at zero torque, positive and negative relative movements can easily be identified on the basis of braking torques which act positively or negatively.

In order to protect the sensor elements 40 and 41 or the sensor device 42, this may be cast or integrated into a housing (not shown).

In addition to the braking torque sensor device 36 described above, a force measuring pin may also be used as a redundant sensor, and may be installed within the suspension device 2. This force measuring pin can detect bending forces within the suspension system 2 which are caused by the braking torque Mr. This additional sensor could be integrated in the suspension device 2, e.g. at a location 44 in the suspension system 2, or in the region of a bearing point 45 of the suspension system 2.

The structure and operation of an additional brake application force sensor device 50 can be seen in FIG. 4 in particular. In the position shown in FIG. 4, the actuator 20 has spread the brake levers 13 and 14 such that the brake pads 15 and 16 rest against the brake disk 17. If the actuator 20 spreads the brake levers 13 and 14 further when they are already in contact with the brake disk 17, the brake levers flex outwards, even if only slightly, due to the effective brake application forces. The deformation is indicated schematically in FIG. 4 for the left-hand brake lever 13 alone. The brake lever 13 is mounted at two points as explained above. Since both the brake bridge and the bearing points 9 and 10 or 11 and 12, together with the actuator 20, are so designed as to be significantly more rigid than the brake levers 13 and 14, their deformation is quasi zero. Therefore if the brake levers 13 and 14 are pivoted about the rigid brake bridge as a result of activation of the actuator 20, an initial position La is established for the brake lever 13 as soon as the clearance has been closed and the brake pads 13 and 14 are in contact with the brake disk 17. As a result of further activation of the actuator 20, the brake lever 13 is pushed out via the bearing pair 9 and 11 on the rigid brake bridge and, starting from the initial position La, assumes a flexed position Lv. The actuator 20 therefore presses or pushes the linkage 21 from its initial position Pa to the position Pv, taking the lower lever end in FIG. 4 with it. To this extent, the brake lever 13 widens or flexes by an angle Φ which is produced by the imaginary axes a and b, wherein the axis a connects the bearing centers of the bearing point 9 and the bearing point 21 in the initial position La, and the axis b connects the bearing points of the bearing 9 and the bearing point 21 in the flexed position Lv.

The deformation of the brake lever is therefore dependent on the application force of the actuator 20, such that the deformation provides a representative value for the braking force which is transferred from the actuator 20 via the brake levers 13 and 14 to the brake pads 15 and 16. It is understood that the deformation described in relation to the left-hand brake lever 13 occurs analogously in the right-hand brake lever 14.

As shown in FIG. 1, this means that not only is the left-hand brake lever 13 equipped with the brake application force sensor device 50, but the right-hand brake lever 14 is also equipped with a further brake application force sensor device 51. The brake application force sensor device is moreover preferably embodied redundantly for each brake lever 13 and 14, such that each lever arm of the two brake levers 13 and 14 has a brake application force sensor device. Accordingly, in FIG. 1 the upper left-hand lever arm 13′ has the brake application force sensor device 50, the lower lever arm 13″ has the brake application force sensor device 50′, the upper right-hand lever arm 14′ has the brake application force sensor device 51 and the lower right-hand lever arm 14″ has the brake application force sensor device 51′.

The four brake application force sensor devices 50, 50′, 51 and 51′ are identical in terms of structure and function. Therefore the determination of force by means of the brake application force sensor devices is explained below in an exemplary manner for only the brake application force sensor device 50 on the upper left-hand lever arm 13′ with reference to FIG. 4.

The brake application force sensor device 50 has a reference part 55 which extends parallel to the lever arm 13″ at a certain distance therefrom, wherein the reference part 55 is securely connected to the brake lever 13 as closely as possible to the region of the rigid brake bridge. Since by virtue of its rigid design the brake bridge undergoes quasi zero deformation when the brakes are activated, the reference part 55 likewise is exposed to virtually no forces which could deform it. The reference part 55 therefore at all times characterizes the braking state which is free of force. By contrast, the brake lever 13′ acting as a tracer part of the brake application force sensor device 50 flexes according to the brake application forces, while the reference part 55 retains its shape and its position virtually unchanged. Therefore the deformation of the brake lever 13′ relative to the reference part 55 can be determined by the brake application force sensor device 50 as a measurement of the active application force.

It can be seen in FIG. 4 that the tracer part or the brake lever arm 13′ flexes, starting from the axis a to the axis b, while the reference part 55 maintains its position in the initial position indicated by the axis a. For the purpose of determining the deformation or displacement of the tracer part or brake lever 13′ relative to the reference part 55, any type of brake application force sensor unit based on any physical measurement principle may be used. At least one sensor element of such a sensor unit is advantageously integrated in the end of the reference part 55, wherein a longer design of the reference part 55 will result in greater deformation of the brake lever 13′ being detected by the sensor element.

As shown by way of example in FIG. 2, a brake application force sensor unit 56 may be composed of two components, namely a first sensor part as an emitter 57 and a second sensor part as a receiver 58.

The position at which these sensor parts are attached may differ in respect of reference part 55 and tracer part or brake lever arm 13′. The emitter 57 generates a signal which is detected by the receiver 58. The emitter 57 attached to the brake lever 13′ follows the deformation of the brake lever 13′. Therefore the signal output by the emitter 57 is also changed or deflected accordingly, this change being detected by the receiver 58. The detected measurement signal can then be sent from the receiver 58 to an evaluation device (not shown), again via e.g. a radio transmission, and evaluated there. For example, optoelectronic or Hall effect sensor elements may be used as emitters and receivers.

Specifically the reference part 55 may be cast with the brake lever 13′, e.g. using a resin or silicone, in order to protect against external influences. It is thereby possible also to moderate the influence of shocks or vibrations acting on the brake lever 13′, such that the reference part 55 always retains the same shape and does not actually undergo any distortion or deformation.

Finally, it must also be noted that the invention is in no way applicable solely to disk brakes in rail-borne vehicles, but may also be used in wind power installations and material handling equipment, for example.

1-18. (canceled)

19. A brake application device for a disk brake system, the brake application device comprising:
a flexible region subject to flexural bending in dependence on a braking torque during a braking operation;
a braking torque sensor device adjacent said flexible region, said braking torque sensor device including an arm-shaped reference element for detecting any deformation caused to the brake application device during the braking operation and a tracer element to be displaced by the flexural bending.

20. The brake application device according to claim 19, which comprises a suspension system, and wherein said flexible region is formed in a vicinity of said suspension system.

21. The brake application device according to claim 19, which comprises a brake bridge holding brake levers of the disk brake system, and a suspension system, and wherein said flexible region is formed by a tapering between said brake bridge of the brake application device and said suspension system.

22. The brake application device according to claim 19, wherein said arm-shaped reference element extends over said flexible region.

23. The brake application device according to claim 21, wherein said arm-shaped reference element is fastened at one end to a side of said flexible region closest to said suspension system, and said tracer element is attached to the brake application device on a side of said flexible region farthest from said suspension system, and comprising a braking torque sensor unit configured to convert a position of said reference element relative to said tracer element into a braking torque measured variable that corresponds to the braking torque.

24. The brake application device according to claim 23, wherein said tracer element is attached to said brake bridge and said arm-shaped reference element is attached below said suspension device.

25. The brake application device according to claim 23, wherein said tracer element is fastened below a neutral axis of said flexible region and said braking torque sensor unit is configured to generate a braking torque measured variable that corresponds to an angle between said tracer element and said reference element.

26. The brake application device according to claim 23, wherein said braking torque sensor unit comprises a first sensor element attached to a free end of said reference element, and a second sensor element attached to said tracer element and located adjacent said first sensor element.

27. The brake application device according to claim 19, wherein said braking torque sensor unit is an optoelectronic sensor unit or a Hall effect sensor unit.

28. The brake application device according to claim 19, wherein said suspension system comprises a force measuring pin contained therein.

29. The brake application device according to claim 19, which comprises at least one brake application force sensor device having a tracer part attached to at least one brake lever of the brake application device so as to output a brake application force measured variable that represents an extent of the flexural bending of the brake lever during the braking operation.

30. The brake application device according to claim 29, wherein said brake application force sensor device further comprises a reference part fastened on one side at its end facing the bearing point of said brake lever, and said tracer part is so connected to said brake lever as to follow a deformation of said brake lever, and a brake application force sensor unit is configured to convert a position of said reference part relative to said tracer part into a brake application force measured variable representing a brake application force.

31. The brake application device according to claim 30, wherein said reference part and said tracer part are positioned on an inner and/or outer surface of said brake lever, and said brake application force sensor unit is configured to generate a brake application force measured variable representing a distance of said tracer part from said reference part.

32. The brake application device according to claim 30, wherein said reference part and said tracer part are positioned on at least one lateral surface of said brake lever, and said brake application force sensor unit is configured to generate a brake application force measured variable representing an angle enclosed between said tracer part and said reference part.

33. The brake application device according to claim 29, wherein said brake application force sensor unit comprises of a first sensor part attached to a free end of said reference part, and a second sensor part attached to said tracer part.

34. The brake application device according to claim 33, wherein said first sensor part is integrated in said reference part.

35. The brake application device according to claim 29, wherein said brake application force sensor unit is an optoelectronic sensor unit or a Hall effect sensor unit.

36. The brake application device according to claim 29, which further comprises a radio connection from said brake application force sensor unit to a central evaluation device.
